(19) United States
(12) Patent Application Publication
(10) Pub. No.: US 2006/0037969 A1
(43) Pub. Date: Feb. 23, 2006

(54) Robotic beverage server

(76) Inventors: Craig Jennings, Dayton, OH (US); Mike Katchmar, Troy, OH (US); Wade Hickle, Vandalia, OH (US); Zane Allen Michael, Troy, OH (US); Donald Joseph Metz, North Hampton, OH (US)

Correspondence Address: DINSMORE & SHOHL LLP;One Dayton Centre, Suite 1300, One South Main Street, Dayton, OH, 45402-2023, US

(21) Appl. No.: 11/210,249

(22) Filed: Aug. 23, 2005

Related U.S. Application Data
(60) Provisional application No. 60/603,712, filed on Aug. 23, 2004.

(51) Int. Cl. B67D 5/56

(52) U.S. Cl. 222/129.1

(57) ABSTRACT

A robotic beverage server includes a robot, a beverage supply disposed near the robot, a computer connected to the robot, and a beverage ordering system connected to the computer. The computer is configured to permit the entry of the type of available beverages stocked in the beverage supply and operable to determine the variety of beverages and mixtures of beverages that will be available for serving by the robotic beverage server based upon the beverages stocked in the beverage supply. The robotic beverage server may also include a controller, a framework, and a barrier disposed above the framework and having an opening therein, wherein both the framework and barrier at least partially encompass the robot and are configured to prevent an user from gaining access to the robot.

### CROSS REFERENCE TO RELATED APPLICATIONS

This application claims the benefit of U.S. Provisional Application No. 60/603,712 filed Aug. 23, 2004.

### BACKGROUND OF THE INVENTION

The present invention relates to automatic beverage servers, more particularly to robotic beverage servers for taking a customer's beverage order and then preparing and serving the beverage to the customer.

Many commercial establishments such as bars, restaurants, and casinos offer a variety of beverages, including mixtures of beverages, for their patrons to consume. Typically, these establishments use human bartenders to perform the task of preparing and serving these beverages. Although using a human bartender has its benefits, there are also many issues as well. For example, in this line of work, there tends to be a high level of turnover. This turnover adds costs to the operation due to frequently having to spend large amounts of time and money recruiting and re-training individuals.

Anytime a business employs people, it also must deal with employee performance issues such as poor attendance, tardiness, sub-par performance, and a variety of other issues. Management ends up spending extensive amounts of time dealing with these employee issues, which ends up taking management's time away from other critical items such as operational matters and the customer. Having employees also adds substantial cost to an operation due to having to pay employee salaries, benefits, training, and other ancillary costs associated with having employees.

These type of commercial establishments also are constantly looking for a gimmick or niche to attract and entertain customers. The establishments want to create some unique identifier for their business that sets them apart from the rest of their competitors. It is desired to find something that draws customers to their establishment over a competitor's.

The known robotic beverage servers generally are relatively large, expensive, and capable of single tasking. There is a need for an apparatus and system that can perform the necessary tasks of preparing and serving beverages in an economical and efficient manner. There is a further need to provide an apparatus and system that can provide entertainment to the patrons of an establishment. In addition, there is a need to provide an apparatus and system that can prepare and serve a high volume of beverages very efficiently and quickly. Due to the cost of commercial real estate, foot print efficiency of such an apparatus and system is also desirable. The apparatus and system should be able to perform the task of preparing and serving beverages in a safe and efficient manner. There is a need for such an apparatus and system that is also portable and easily transported. These needs are met by the apparatus and system of the present invention.

### SUMMARY OF THE INVENTION

Accordingly, the present invention is intended to address and obviate problems and shortcomings and otherwise improve previous robotic beverage servers.

One exemplary embodiment of the present invention is a robotic beverage server that includes a robot, a beverage supply disposed adjacent to the robot, a computer connected to the robot, and a beverage ordering system connected to the computer. The computer is configured to permit the entry of available beverages stocked in said beverage supply and operable to determine the variety of beverages and mixtures of beverages that will be available for serving based upon said beverages stocked in said beverage supply.

Another exemplary embodiment of the present invention is a robotic beverage server that includes a robot, a framework at least partially encompassing the robot, a beverage supply disposed within the framework, a barrier disposed above the framework such that the barrier at least partially encompasses the robot and includes an opening therein, and a controller configured such that the robot cooperates with the beverage supply to serve a beverage or mixture of beverages from the beverage supply to an user through the opening. The framework and barrier are configured to prevent an user from gaining access to the robot.

Another exemplary embodiment of the present invention is a robotic beverage server that includes a robot, a framework at least partially encompassing the robot, a beverage supply and a beverage container supply disposed within the framework, and a barrier including an opening and disposed along the framework such that the barrier at least partially encompasses the robot. a barrier disposed along said framework such that said barrier includes an opening therein and at least partially encompasses said robot, a beverage delivery device disposed at said opening of said barrier, and a controller. The beverage delivery device is configured such that when the robot places a beverage container thereon, the beverage delivery device moves the container to the opening and permits a customer access to only the beverage container behind the barrier. In addition, the controller is configured to cause the robot to pick a beverage container from the beverage container supply and to cooperate with the beverage supply to serve a beverage or mixture of beverages from the beverage supply.

### BRIEF DESCRIPTION OF THE DRAWINGS

The following detailed description of the preferred embodiments of the present invention can be best understood when read in conjunction with the following drawings, where like structure is indicated with like reference numerals and in which:

FIG. 1 is a perspective view of an exemplary embodiment of a robotic beverage server;

FIG. 2A is a perspective view of an exemplary embodiment of the robot of the robotic beverage server shown in FIG. 1;

FIG. 2B is a side elevational view of the exemplary robot shown in FIG. 2A;

FIG. 2C is a front view of the exemplary robot shown in FIG. 2A;

FIG. 3 is a front elevational view of the robotic beverage server shown in FIG. 1;

FIG. 4 is a top plan view of the robotic beverage server shown in FIG. 1;

FIG. 5 is a perspective view of an outer cylindrical housing of an exemplary embodiment of the beverage delivery device shown in FIG. 1;

FIG. 6 is a perspective view of an inner hollow cylinder of an exemplary embodiment of the beverage delivery device shown in FIG. 1; and

FIG. 7 is a side elevational view of the inner hollow cylinder shown in FIG. 6.

### DETAILED DESCRIPTION OF THE INVENTION

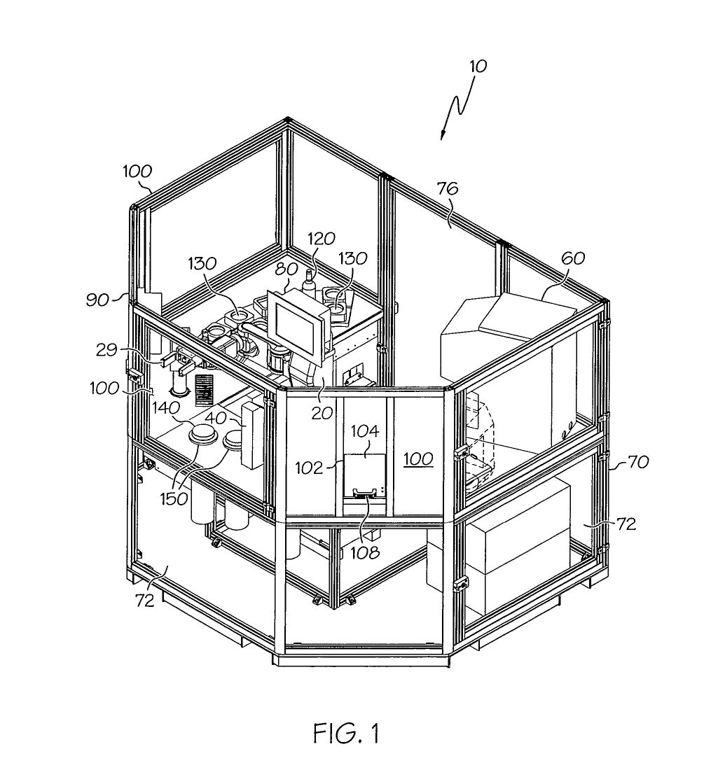

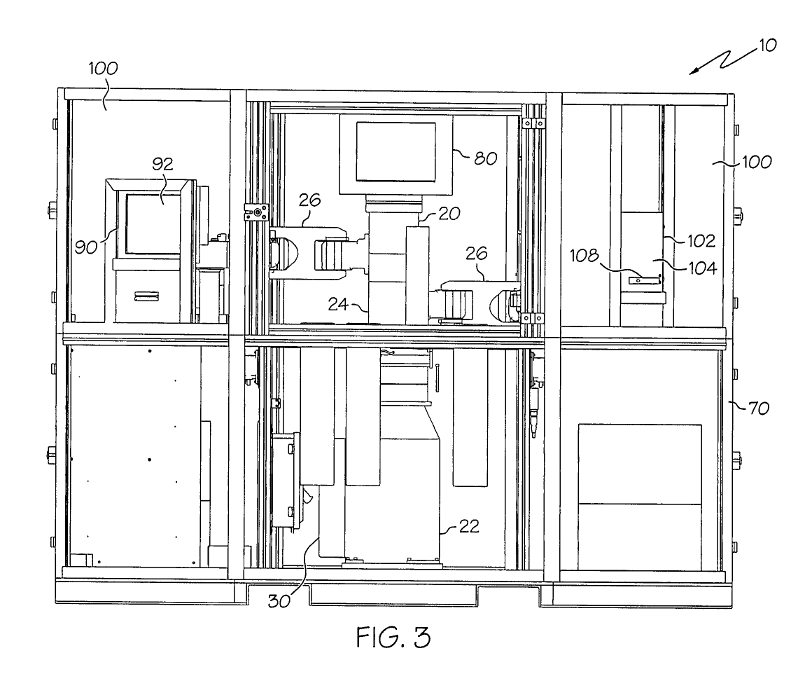

Referring now to FIGS. 1-10, an exemplary embodiment of a robotic beverage server 10 of the present invention is shown. Robotic beverage server 10 of this exemplary embodiment may include a robot 20, a controller 30, a beverage supply (e.g., first beverage dispenser 40 and second beverage dispenser 50), a beverage container supply (e.g., beverage container dispenser 150), an ice dispenser 60, a framework 70, a barrier 100, a display panel 80, a beverage ordering system 90, and a beverage delivery device 110. Robotic beverage server 10 of this embodiment may serve, for example, dispense, prepare and/or serve, a variety of single beverages or mixtures of beverages, including but not limited to draft beer, bottled beer, shots of liquor, wine, malted beverages, sodas, juices, water, coffees, cappuccinos, lattes, mixed drinks, cocktails, and/or any combinations thereof.

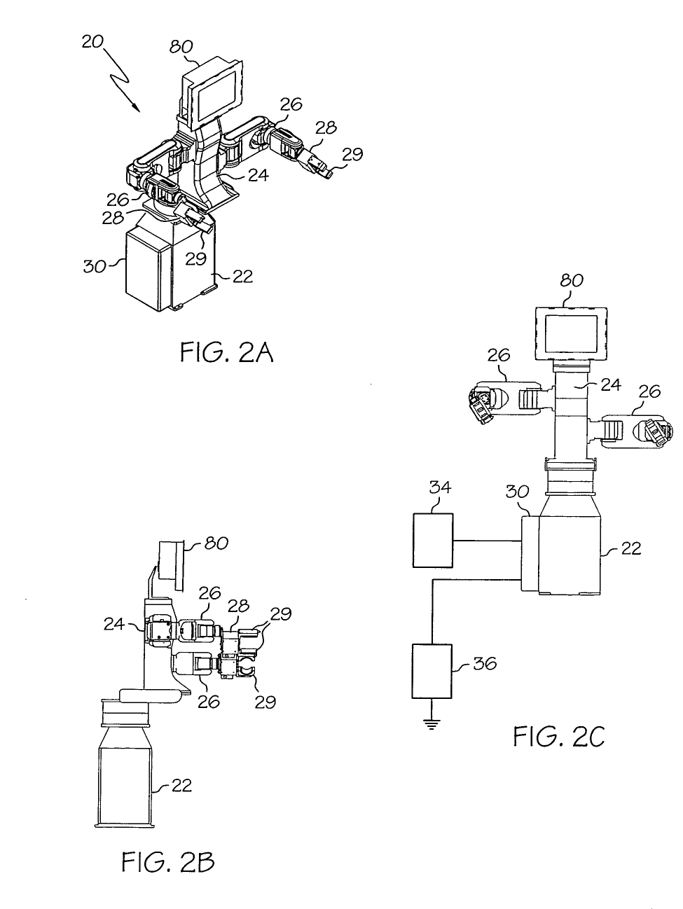

FIGS. 2A-2C show an exemplary embodiment of robot 20 of the present invention. Robot 20 may comprise any robot commonly known in the art, including but not limited to commercial off-the-shelf robots (e.g., industrial articulated arms, human-like robots, etc.) and/or custom manufactured systems. In one exemplary embodiment, robot 20 is configured to approximate a physical representation of a human body. It is understood that robot 20 may comprise a variety of shapes, forms, and components to approximate a physical representation of a human body. For example, robot 20 may comprise one or more components that have a very mechanical appearance, yet still permit the robot to approximate a physical appearance of a human body, e.g., having a head, torso, and/or one or more arms. In another example, robot 20 may comprise components, including an outer shell, that have a very realistic human appearance to approximate a physical representation of a human body. It is understood that robot 20 may include components that approximate legs, hands, eyes, ears, and/or any other part of the human body.

In the exemplary embodiment shown in FIGS. 2A-2C, robot 20 is configured to approximate a physical representation of a human body by including a torso, head, and arms. When combined, the torso, head, and arms provide robot 20 this human-like appearance. Robot 20 approximates a physical representation of a human body, even though robot 20 has a very mechanical and/or robotic appearance. In this exemplary embodiment, robot 20 comprises a torso 24, a head (e.g., display panel 80) connected to a top part of torso 24, and two robotic arms 26 connected to opposite sides of torso 24. Also, robot 20 includes base 22 which is disposed along the ground and connected to torso 24.

Each robotic arm 26 may include a gripper 28 for gripping items (e.g., a beverage container 140 or a bottle) or for activating items such as beverage dispenser 40. Any conventional robot gripping device as known to one of ordinary skill in the art may be used with robot 20 without departing from the spirit and scope of the present invention. As shown, the exemplary embodiment includes gripper 28 that includes two actuated fingers 29 that are parallel to each other. When operated, fingers 29 move either inwardly towards each other or outwardly away from each other in a parallel orientation. Grippers 28 may be connected to and controlled by the robots servo control system or a separate pneumatic control system. In one exemplary embodiment, grippers 28 have a separate pneumatic control system with its own power supply and controller (e.g., microprocessor).

Robot 20 may rotate 360 degrees at its base 22 in order to cooperate with, pick, or operate any of the items and/or devices disposed along framework 70. Each arm 26 may move along and/or about multiple axes. Robot 20 of this exemplary embodiment may have arms that move along and/or about 5 axes. The robot of the exemplary embodiment is commercially available from MOTOMAN, Inc., of West Carrollton, Ohio (hereinafter “MOTOMAN”), a subsidiary of YASKAWA Electric America, Inc., of Oakbrook, Ill. In an alternative embodiment, robot 20 may be a single articulated robotic arm capable of multi-axis movement, for example, a six-axis robotic arm. Such articulated, robotic arms are also commercially available from several commercial suppliers such as MOTOMAN, Inc., West Carrollton, Ohio.

As shown in FIG. 2C, a robotic controller 30 is in electrical communication with robot 20 and may include any conventional input device for programming controller 30 to control and operate robot 20 and any of the other component of robotic beverage server 10 (e.g., first and second beverage dispensers 40 and 50, respectively) as known to one of ordinary skill in the art. Controller 30 and/or robot 20 may be connected to a power supply 36. Power supply 36 may be any conventional power supply such as those used in the robotic arts as known to one of ordinary skill in the art.

In an alternative embodiment, controller 30 includes a programming pendant 34 to serve as the input device as shown in FIG. 2. Programming pendant 34 may include a WINDOWS operating program (e.g., WINDOWS CE), a programming language, and/or a PC architecture. Any conventional robotic programming language and PC architecture as known to one of ordinary skill in the art may be used with the present invention. The programming language would be well understood by one skilled in the art and need not be described in detail herein. In an alternative embodiment of the present invention, the programming language may comprise the INFORM series of programming languages that are commercially available from MOTOMAN, Inc., West Carrollton, Ohio. Generally, controllers 30 are separate and located a distance from the robot. However, in the exemplary embodiment of the present invention, controller 20 is located within base 22 of robot 20 to improve the footprint of robotic beverage server 10, thus saving valuable floor space.

Robotic beverage server 10 may also include a computer (not shown) that contains system programming that interfaces with the controller 30 and its robotic control and/or other robotic beverage server control programming. The computer may be configured to send, retrieve, and collect control signals and data. The controller (30) and/or the computer may be configured to determine what beverages or mixtures of beverages (types of cocktails) will be available based upon the variety of beverages (e.g., liquors and cocktail mixers such as juices, water, fruit drinks, carbonated beverages and sodas, energy drinks, etc., and/or other beverages) stocked in robotic beverage server 10.

For example, an operator may enter into the computer that vodka, rum, tequila, orange juice, and carbonated beverages and sodas are stocked in the robotic beverage server. Controller 30 and/or the computer will determine all the different beverages or mixture of beverages that may be dispensed and served based upon these available (stocked) beverages such as “Screwdriver”, “Margarita On-The-Rocks”, etc. Controller 30 and/or the computer may then send this data to be displayed on beverage ordering system 90 and/or display panel 80 to inform an user (e.g., consumer) what beverages or mixtures of beverages are available to be served by robotic beverage server 10. Controller 30 and/or the computer may also be configured to be customizable by the operator such that the operator may change the types of beverages (e.g., liquors, beers, and/or other beverages) that are stocked within the robotic beverage server, and controller 30 and/or the computer will re-determine the variety of beverages and mixtures of beverages that are available for serving based upon the newly entered stocked beverages.

The computer may also be configured to collect, track, and store all inventory, accounting, sales, and revenue data. In addition, the computer may be configured to track this inventory, accounting, sales, and revenue data by time and date. For example, the computer may track, collect, and store the number of beverages prepared and served by type and time and the revenues collected by type and time. The computer can compare the beverages served versus the dollars charged to ensure the proper charges have been applied to protect against theft or errors. The computer and/or robotic beverage server 10 may be connected to other systems and/or networks such as a LAN, WLAN, or the Internet via standard hardwire connections or wireless communications (e.g., WIFI), allowing data to be collected and aggregated from one or more robotic beverage servers on-site or remotely.

Memory may be connected to or included with controller 30 and/or the computer. The memory may be used to store data such as display (e.g., graphic or textual representations) or sound (e.g., voice) data, inventory data, accounting data, sales data, and/or revenue data. The memory may be any conventional memory as known to one of ordinary skill in the art.

As described above, robotic beverage server 10 may also include display panel 80 attached to the top of torso 24 of robot 20 as shown in FIG. 2. Display panel 80 may be any known conventional and/or commercially available display panel without departing from the scope of the present invention. In one exemplary embodiment, display panel 80 is a multi-pixel display panel, including but not limited to a television and/or monitor (e.g., LCD monitors, plasma screen monitors, etc.). Display panel 80 is in electrical communication with controller 30 and may be configured to display a variety of graphic and/or textual representations thereon based upon display data transmitted from either the computer or controller.

The computer and/or the controller may be configured to permit the consumer to select the gender of or what type of server the robot may be. For example, the computer and/or controller may be configured to permit the consumer to select the gender (e.g., male or female) of the robot such that a gender specific image may be displayed on display panel 80 and/or a gender specific voice corresponding to the gender selection may be transmitted from the robotic beverage server to communicate with the consumer. Once the consumer picks the gender, the computer and/or controller will display a face of a male or female server (e.g., bartender) up on display panel 80. In an alternative embodiment, the computer and/or controller will permit the consumer to pick his/her favorite celebrity (e.g., movie star, sports star, etc.) and/or fictional character (e.g., cartoon character, book character, etc.); at which point, the system will display the face of the celebrity chosen by the consumer on display panel 80.

The computer and/or controller may also be programmed to use the display panel 80 to display customer or operator messages. For example, the display panel 80 may display messages describing to the customer what stage of the operation the robotic beverage server is currently performing such as “Now retrieving ice”, “Now pouring liquor”, “Now retrieving Mixer”, “Mixing drink”, and/or “Drink now served”. It is understood that a variety of other textual or oral messages may be transmitted from the robotic beverage server to communicate to an user (e.g., consumer). The computer and/or controller may also be configured to advertise drink specials or consumer/operator warnings and alerts on display panel 80 as well. The computer and/or controller may also be configured to have a voice that communicates to and/or interacts with the customer. It is understood that robotic beverage server 10 may include one or more conventional speakers to transmit the variety of oral messages, verbal interaction, and/or songs or other sounds.

Referring to FIGS. 1, 3, and 4, robotic beverage server 10 may include a beverage supply. The beverage supply of the present invention may include a variety of conventional or yet-to-be developed devices or methods to supply and/or dispense a beverage, including but not limited to conventional soda and other beverage dispensers (e.g., carbonated beverage dispensers including a dispensing tower), beer taps (connected to kegs), bottled beverages (e.g., bottled beer, wine, and/or liquor), coffee/cappuccino dispensers, and or any other type of beverage supply capable of supplying and/or dispensing any type of beverage. As shown in exemplary embodiment of FIGS. 1, 3, and 4, the beverage supply includes a first dispenser 40, a second dispenser 50, and an active and supply row of beverage bottles (e.g., liquor bottles).

In the exemplary embodiment, first dispenser 40 dispenses non-alcoholic beverages, including but not limited to sodas (i.e., carbonated drinks), fruit juices and drinks, tonic water, water, club soda, draft beer and other types of beverages, particularly those used for mixing with liquors in order to make cocktails/mixed drinks. First beverage dispenser 40 may include, for example, a touch pad or button 42 for each beverage option, a spout (not shown), at least one beverage receptacle (not shown) for holding the beverage available for serving or mixing, and at least one distribution line (not shown) connecting the beverage receptacle to the spout 44. The beverage dispenser 40 may use a pressurized system such as a carbon dioxide system to pump the beverages from the receptacles to the spout when dispensing. If the button 42 for a particular beverage is pushed, that particular beverage is dispensed from its receptacle via the line and dispensed from the spout into a beverage container. Such a beverage dispenser is known to one of ordinary skill in the art.

In another alternative embodiment, first beverage dispenser 40 may be manually activated to dispense the beverage via the beverage container hitting a trigger when it is inserted under the spout. In still another alternative embodiment, first beverage dispenser 40 is automatically activated by the system via sensors that detect a beverage container or system programming wherein robotic beverage server is timed to open and close solenoid valves based upon the time required for robot 20 to pick a beverage container and place it under the spout and for the beverage to fill the container.

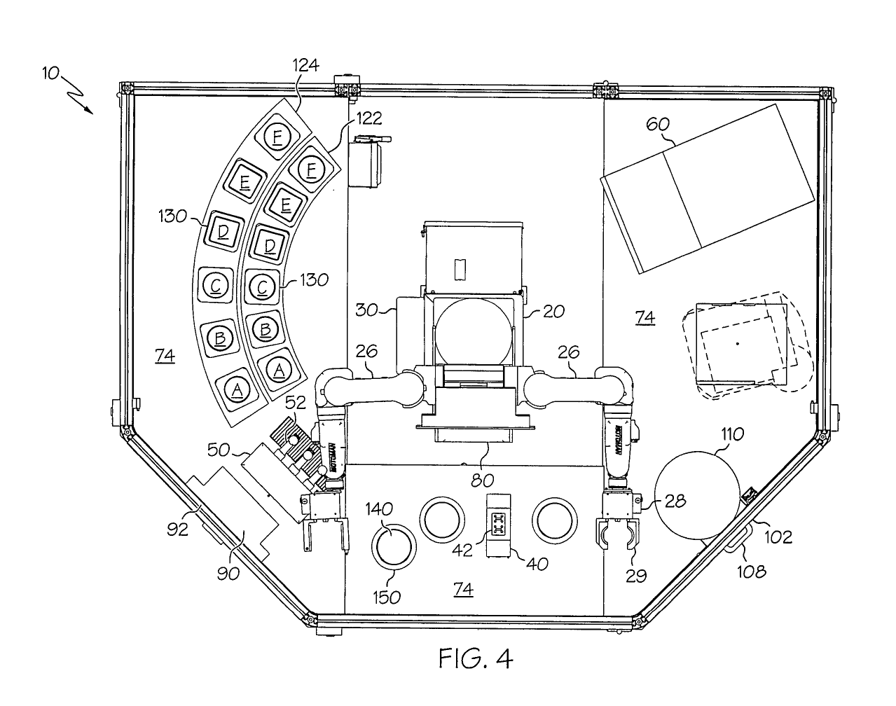

Second beverage dispenser 50 of the beverage supply may also be any conventional or yet-to-be developed device configured to dispense one or more beverages as known to one of ordinary skill in the art without departing from the spirit and scope of the present invention. However, in this exemplary embodiment, it is a draft beer dispenser (e.g., draft beer tap and keg) as known to one of ordinary skill in the art. Second beverage dispenser 50 includes at least one keg (not shown) containing beer connected via at least one beer line, i.e., distribution line (not shown) to at least one dispensing tap 52 shown in FIG. 4. The second beverage dispenser may also use a pressurized system to pump the beer from the kegs to tap 52 and/or nitrogen to cool the beer within the dispenser, all of which is commonly known to those skilled in the art.

In one alternative embodiment, tap 52 has a solenoid valve that is open and closed by controller 30 and may control the dispensing of the beverage (e.g., beer) at tap 52. For example, when an user (e.g., consumer) orders a beer, the system has been programmed to for the robot to pick (grab and hold) a beverage container and place it under tap 52. Controller 30 signals a solenoid valve (not shown) connected to tap 52 to open and begin dispensing the beverage from the appropriate tap and to close when the appropriate amount of beverage has been dispensed.

Although the exemplary embodiment shown and described herein includes both a first and second beverage dispenser 40, 50, respectively, it is understood that the first and second beverage dispensers may be combined into one beverage dispenser without departing from the scope of the invention. For example, conventional beverage dispensers exists that are capable of dispensing both alcoholic (e.g., beers, wines, liquors, etc.) as well as non-alcoholic beverages (e.g., sodas, water, fruit juices, etc.). In one such example, a dispensing head may contain a button for each beverage available and be connected to a plurality of lines, which are connected to a variety of receptacles holding the beverages available to be served.

The beverage distribution lines for the first dispenser and/or the second dispenser may be connected to or run through a manifold (not shown). This manifold may be made from metal, preferably aluminum and then exposed to a cooling medium such as ice and/or a refrigeration unit that cools the manifold, which in turn, cools the beverages as it passes through the manifold. In one particular embodiment, the manifold and the distribution lines running through the manifold are placed in a cooler filled with ice, wherein the ice chills the manifold, lines, and beverages that pass through the manifold.

Robotic beverage server 10 may also include an ice dispenser 60. The ice dispenser 60 may be any conventional or yet-to-be developed ice dispensing machine as known to one of ordinary skill in the art. Generally, ice dispenser 60 may include a storage receptacle (not shown) that holds the ice until it is dispensed and a dispensing apparatus (not shown) that, upon its activation, dispenses the ice from the storage receptacle into a beverage container. In an alternative embodiment, the ice dispenser 60 may include an ice making device (not shown) as known to one of ordinary skill in the art. Again, the ice making device is well known to those skilled in the art and need not be described in detail herein.

Still referring to FIGS. 1, 3, and 4, robotic beverage server 10 may include a framework 70. In the exemplary embodiment shown, framework 70 is substantially U-shaped and designed to look like a bar. It includes a countertop 74 and panels 72 enclosing the framework 70 to form storage cabinets underneath countertop 74. Framework 70 may be manufactured from any type of structural materials, including but not limited to metal, plastics, polymers, wood, and any combination thereof. Panels 72 may be made of plastic, glass, metal, wood, polymer, and any combination thereof. Panels 72 may be opaque, clear, painted, tinted, or any combination thereof. In this particular embodiment, framework 70 is made from aluminum. A portion of the panels 72 are clear plastic and a portion are metal. Preferably, the material chosen is light weight to keep framework 70 as light as possible for ease in transportation. In addition, in one exemplary embodiment countertop 74 is fabricated from stainless steel for sanity purposes.

In one alternative embodiment, a portion of cabinets 72 are refrigeration units, wherein the kegs of beer may be stored and cooled. Another portion of the cabinets may contain inventory such as beverage containers, liquor bottles, etc. Another portion of the cabinets may contain the beverage receptacles that are connected to the beverage dispenser 40. The countertop 74 is optionally made of stainless steel to meet health codes. The countertop 74 enables the robot to rest items on it and the robotic beverage server system to more closely resemble a bar. In addition, the liquor bottles may be placed on top of the countertop 74 for convenience and aesthetic purposes.

The exemplary embodiment may also include a barrier 100. Barrier 100 may be a cage that prevents persons from reaching or climbing over countertop 74 such as metal bars or fencing. In the exemplary embodiment shown, barrier 100 is a series of windows that completely enclose robotic beverage server 10, preventing unauthorized access to or interference with robotic beverage server 10 and its operation. This barrier also may prevent persons from injury due to getting hit by robot 20. Barrier 100 may also prevent theft, vandalism, or unauthorized access to the robotic beverage server's supplies (e.g., alcohol). Barrier 100, in this exemplary embodiment, is made of plastic such as PLEXIGLAS, to permit the customer to see through barrier 100 but still prevent persons from accessing robotic beverage server 10. It is understood that barrier 100 may be made from other materials, including opaque materials. The back of framework 70 and barrier 100 may include a door 76, allowing access to the inside of robotic beverage server 10, i.e., behind countertop 74.

In the exemplary embodiment shown, a beverage container supply 150. The beverage container supply may include a variety of conventional container supplies as known to one of ordinary skill in the art. For example, beverage container supply 150 may comprise a container dispenser commonly found in concession type stands, i.e., a spring-loaded cup dispenser, wherein a plurality of drinking cups are stacked upside down or right-side up into the dispenser. As each cup is pulled from the dispenser, the dispenser pushes the stacked upward such that the next cup is exposed and available for dispensing. Such a beverage container dispenser is known to one of ordinary skill in the art and need not be described in detail herein. Other conventional beverage container dispensers as known to one of ordinary skill in the art may be used without departing from the spirit and scope of the present. Beverage container supply 150 may be attached to framework 70 such that the beverage containers 140 (e.g., cups, glasses, etc.) are protruding through an opening in countertop 74. However, it is understood that container supply 150 may be any type of conventional container dispenser without departing from the scope of the present invention, even including but not limited to a conveyor supplying containers or multiple containers sitting on countertop 74.

Barrier 100 may also include an opening 102, wherein an access opening device 104 is positioned. Access opening device 104 may be any apparatus that permits access to and through opening 102 to access a prepared beverage being served by robotic beverage server 10. Access opening device 104 may comprise a sliding window attached to barrier 100 that is configured to open or close opening 102. It is understood that access opening device 104 may include other conventional devices capable of opening and closing opening 102 such as a hinged door or window, sliding drawer, etc., as known to one of ordinary skill in the art.

In the exemplary embodiment shown, access opening device 104 is, as described above, a serving window built into barrier 100. Serving window 104 includes a panel that is configured to slide vertically upwards and downwards to open or close opening 102 barrier 100. Window 104 may include a handle 108 that the consumer may grip when opening the window. In an alternative embodiment, the access opening device 104 includes a sensor (not shown) that is in communication with controller 30 such that sensor may detect whether access opening device 104 is in the open or closed position and signal this data to controller 30 and/or the computer. Access opening device 104 may also include a lock (not shown) that when engaged prevents the access opening device from being opened by an user (e.g., consumer).

In an alternative embodiment, the entire framework 70 is one unit. In another alternative embodiment, framework 70 may be comprised of multiple components that easily connect together to form a single framework 70. The multiple component framework is beneficial due to simplifying and providing an easier method for transporting and moving robotic beverage server 10. In addition, the multiple components permit robotic beverage server to be sized such that it may fit through a variety of doorways, thus not requiring large doorways in order to maneuver through. The multiple components are designed such that they may connect and disconnect relatively simply and quickly. The connections used to connect the multiple framework components together may comprises a variety of conventional connections, including but not limited to bolt and nut connections, screws, snap-fit, latch connections, or any other type of devices used to connect components together to form a single connected unit. In an alternative embodiment, framework 70 may be comprised of multiple components that are simply positioned next to each other without physically being connected to one another to form framework 70. Framework 70 or its multiple components may also include wheels or casters attached to its bottom to enable it to be rolled and maneuvered into position.

Robotic beverage server 10 may also be configured (e.g., controller 30 may be configured) to pour beverages from beverage bottles or other types of containers. The beverage bottles may include bottled beers, sodas, juices, water, liquor, malted beverages and any other suitable beverage as described herein or known by one of ordinary skill in the art. It is also understood that robotic beverage server 10 may be configured to pour beverages from other containers besides bottles such as cartons, cans, etc.

In the exemplary embodiment, the beverage supply of robotic beverage server 10 may include a plurality of liquor bottles 120 positioned along countertop 74 in an active row 122. As shown in FIG. 1, active row 122 includes one or more beverage bottles in a non-dispensing orientation along countertop 74. Non-dispensing orientation, as used herein, is defined as a container or bottle positioned such that it cannot dispense the beverage from within until the container or bottle is re-oriented to a dispensing orientation. For example, a bottle with its mouth facing upward is in a non-dispensing orientation and must be tilted to one side (or partially or completely upside down) to dispense the beverage contained within it (e.g., dispensing orientation). In other words, robot 20 must pick and move the beverage bottle to a dispensing orientation (e.g., tilt the beverage bottle 120). It is understood, however, that active row 122 may include beverage bottles in a dispensing orientation without departing from the spirit and scope of the present invention.

Each of these bottles 120 may include a pour spout (not shown) attached to its opening. In one particular embodiment, the pour spout is a conventional, one-ounce pour spout as known to one of ordinary skill in the art. The position or coordinates of each type of beverage bottle (e.g., liquor) along countertop 74 has been configured within controller 30 and/or the computer such that robot 20 knows the exact location of each type of beverage within active row 122. For example, if an user orders a drink with vodka, controller 30 will operate robot 20 such that it moves robot 20 (and/or one of its robotic arms) to the proper position along active row 122 (e.g., position 122c) such that robot 20 picks (moves, grabs, and picks up) the beverage bottle (e.g. the vodka bottle) at that appropriate position with its gripper 28.

As can be seen in FIG. 4, robotic beverage server 10 may multiple positions 122A, 122B, 122C, 122D, 122E, and 122F within active row 122 for beverage bottles. In addition, the beverage supply may also include a supply row 124 that has multiple beverage bottle positions 124A, 124B, 124C, 124D, 124E, and 124F adjacent to and corresponding to each active row position. Each of the positions in the supply row may contain a beverage bottle in a non-dispensing orientation. The types of beverages (e.g., liquors) and their positions within the rows (active and supply) may vary depending upon the beverages stocked and/or the desired positioning of each beverage of the operator.

In this exemplary embodiment, supply row 124 of beverage bottles is placed directly behind active row 122 of beverage bottles, i.e., farther away from robot 20 than the active row. Each bottle in supply row 124 generally matches the type of liquor found in the bottle in front of it (in the active row). The controller and/or computer is configured to know exactly how many shots or, in this exemplary embodiment, 1 ounce pours, are in each of the beverage bottles available for serving. When the robot pours the last shot from the active bottle, robot 20 is configured to dispose of place the empty bottle (e.g., place the bottle in a trash container) and reach over to supply row 124 to pick a full bottle of that type of beverage and/or liquor. The robot then proceeds to move the second bottle from supply row 124 to the empty position along active row 122 that contained the now disposed of empty bottle. The empty position in the supply row may also serve as a signal to an operator that a new bottle must be re-supplied at that position in the supply row 124. When an operator sees the empty supply position, he may get a new bottle, open it, attach a new pour spout to its opening, and then place it in its position along supply row 124.

The exemplary embodiment may also include bottle position receptacle 130 located at each position 122A-122F and 124A-124F. FIGS. 1 and 4 show one exemplary bottle position receptacle 130 of the present invention. Such bottle position receptacle may be configured to receive a beverage bottle and hold the beverage bottle in its position along either active or supply rows 122 and 124, respectively. In the exemplary embodiment, bottle position receptacle is configured to hold the beverage bottles in a non-dispensing orientation along countertop 74. Bottle position receptacle 130 may also be keyed or sized to only accept a particular bottle type, size and/or shape, which may correlate to a certain brand of beverage as well to prevent an operator from placing a beverage bottle in the incorrect position. In an alternative embodiment, bottle position receptacle 130 and/or robotic beverage server 10 may include one or more orientation indicia such as an arrow to identify the direction and/or orientation the spout needs to be oriented so that the robot will pick and pour the beverage bottle correctly. In an alternative embodiment, the bottle receptacle may include a key to ensure the bottle and spout are oriented correctly.

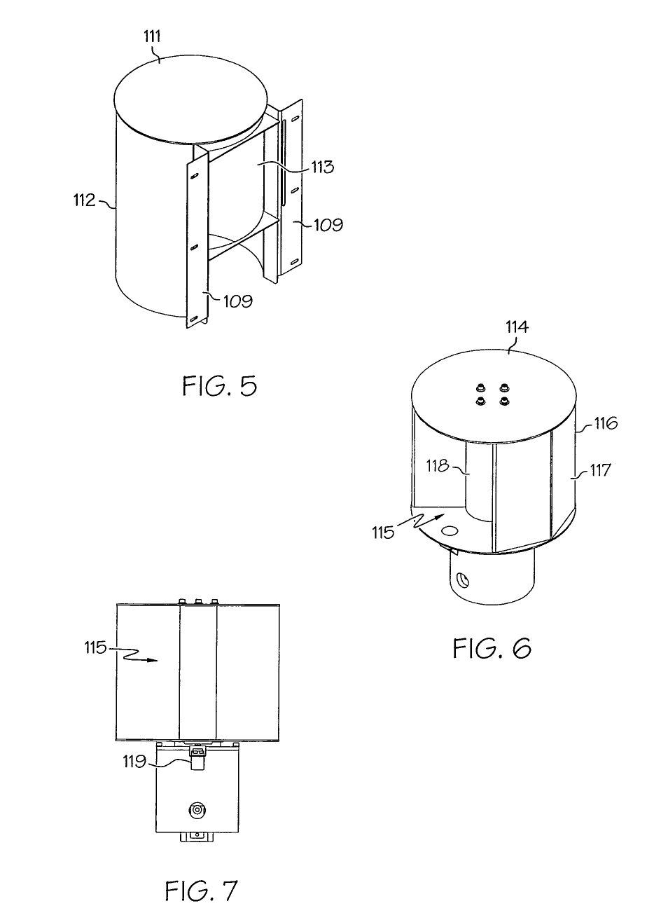

Robotic beverage server 10 may also include a beverage delivery device 110 to deliver a prepared beverage to a consumer. Referring to FIGS. 5-7, an exemplary embodiment of beverage delivery device 110 is shown, wherein it comprises an outer cylindrical housing 111 that contains an inner hollow cylinder 114 rotatable within outer cylindrical housing 111. Outer cylindrical housing 111 includes two openings 112 and 113 substantially 180° from each other. Inner cylinder 114 rotates about a coaxial axis (e.g., vertical axis) within the outer housing 111. The inner cylinder 114 may include a first chamber 115, a second chamber 116 substantially 180 degrees from first chamber 115, and an exterior wall 117. Inner cylinder 114 may also include an inner wall 118 separating first and second chambers 115 and 116, respectively.

Beverage delivery device 110 may be positioned at opening 102 along barrier 100. This permits the prepared beverages to be served to an user (e.g., consumer) through the barrier 100 via the beverage delivery device 110 and opening 102. For example, outer cylindrical housing 111 may include a flange 109 to connect delivery device 110 to barrier 100 as known to one of ordinary skill in the art. It is understood that other conventional devices may be used to connect delivery device 110 to barrier 100 and/or robotic beverage server 10.

Still referring to FIGS. 5-7, the first and second chambers 115, 116, respectively, do not include an exterior wall and thus are open (not enclosed) such that when aligned with first and second openings 112 and 113 of outer cylindrical housing provide access to the first and second chambers in order to place or retrieve a beverage placed within either chamber. However, when first and second chambers 115 and 116 are not aligned with first and second openings 112 and 113, then an outer wall 108 of outer cylindrical housing 111 encloses (closes off) first and second chambers 115 and 116. Thus, outer wall 108 prevents access to either first or second chamber 115 and 116.

The inner cylinder 114 may be pneumatic-controlled and/or electrically-servo controlled. In the pneumatic-controlled embodiment, the inner cylinder may be connected to the same pneumatic valve(s) as the grippers of robot 20. This pneumatic system rotates inner cylinder 114 180° between two positions: a loading position (A) (first opening 112 of outer cylindrical housing 111) and a serving position (B) (second opening 113 of outer cylindrical housing 111). Delivery device 110 is positioned along robotic beverage server 10 such that the outer cylindrical housing's second opening 113 and serving position (B) are disposed at opening 102, permitting an user to access to beverage held whichever chamber (either first or second chamber 115 or 116) is in the serving position (B). It is understood that other devices may be used to deliver the prepared beverage from loading position (A) to serving position (B). For example, a linear sliding and/or conveyor may be used to move a prepared beverage between the two positions.

For illustration purposes, and not limitation, loading position (A) is in a position closest to robot 20, i.e., near the inside edge of countertop 74 as shown in FIG. 4. Serving position B is 180 degrees from the loading position A and thus near the outside edge of countertop 74 as also shown in FIG. 4 as well. When a chamber (either first chamber 115 or second chamber 116) is in serving position B and aligned with opening 113 of outer cylindrical housing 111, the chamber is also aligned with the opening 102.

A first chamber sensor 119 is located at first chamber 115 and configured to detect the presence of a beverage container positioned within the chamber. A second chamber sensor (not shown) is located at the second chamber 116 and is also configured to detect the presence of a beverage container positioned within second chamber 116. In this exemplary embodiment, the sensors comprise an emitter and reflector located at the top and bottom, respectively, of each chamber. These sensors are in communication with the controller and provide feedback information to robotic beverage server 10 to signal whether a beverage container is present within either of the chambers.

For example, if first sensor 119 detects a beverage container within first chamber 115 when first chamber 115 is located at loading position (A) and the second sensor does not detect a container in second chamber 116 (located at serving position (B)), the controller will move first chamber 115 to serving position (B) so the prepared beverage may be picked up by the consumer at opening 102. If the second sensor detects a beverage container in second chamber 116 when it is in serving position B, the controller will not permit inner cylinder 114 to rotate whether or not there is a container in first chamber 115. This is a safety feature to prevent injuries due to beverage delivery device 110 moving when an user's hand may be within the chamber trying to retrieve the prepared beverage. Once the consumer picks up the beverage container within second chamber 116 (at serving position (B)) and closes access opening device 90, the second sensor will detect that the beverage container is no longer in second chamber 116 and will permit delivery device 110 to rotate if first sensor 119 detects a container within first chamber 115. The serving operation described above works for the opposite scenario as well, i.e., if second chamber 116 is in loading position (A) and first chamber 115 is in serving position (B).

Robotic beverage server 10 may include a variety of other safety features to prevent injuries to the consumer. For example, the diameter of outer cylindrical housing 111 and inner cylinder 114 are such that they are within very tight tolerance of each other such that exterior wall 117 of inner cylinder 114 is less than 5.0 mm from outer cylindrical housing 111. In another exemplary embodiment, exterior wall 117 of inner cylinder 114 is less than 1.0 mm from outer cylindrical housing 111. Such tight tolerance between outer cylindrical housing 111 and inner cylinder 114 prevents an user (e.g., consumer) from getting a finger and/or other appendage caught in between the moving inner cylinder and the outer cylindrical housing, causing an injury.

In addition, controller 30 (and/or the computer) may be programmed to not permit the access opening device 104 to open if either robot 20 or beverage delivery device 110 is in motion. Such a safety configuration prevents an user from getting injured by placing a hand through opening 102 while either robot 20 or delivery device 110 are moving. Robotic beverage server 10 may engage a locking mechanism (not shown) on access opening device 104 to prevent it from opening. Controller 30 (and/or the computer) may be configured to not permit beverage delivery device 110 to move, if robotic beverage server 10 detects access opening device 104 is in an open position. This feature is designed to prevent beverage delivery device 110 from rotating while an user's hand (e.g., consumer's hand) may be in one of its chambers, thus preventing an injury to the user. Access opening device 104 may include a conventional sensor (not shown) to detect whether access opening device 104 is in a closed or opened position as known to one of ordinary skill in the art.

Referring back to FIGS. 1-4, robotic beverage server 10 may also include a beverage ordering system 90. Beverage ordering system 90 may comprise a touch screen panel 92 configured to list or display the beverage options available to be served by robotic beverage server 10. Such beverage ordering system 90 may be connected to controller 30 and/or the computer and may send signals to controller 30 based upon consumer input (via touch screen). Touch screen panel 92 may display the beverage options available from the robotic beverage server 10 and other potential user selections available to the user. For example, a consumer may order their beverage choice by touching an icon representing that beverage on touch screen 92. Controller 30 (and/or the computer) may receive the consumer's order and is programmed to send signals to robot 20 to begin preparing the ordered beverage.

Robotic beverage server 10 (e.g., the computer) may also calculate and display the total cost due for the consumer's beverage order on touch panel 92 and/or display panel 80. Touch panel 92 may be configured to allow the consumer to enter a credit card number to pay for the charges. Robotic beverage server 10 may be configured to accept magnetic strip cards (e.g., prepaid account cards, debit cards, credit cards, etc.). Panel 92 may includes a touch icon for the consumer to accept the charged amount and/or approve this amount to be charged to an account the consumer has established with the vendor, a prepaid account card, or a credit card. Beverage ordering system 90 may comprise a kiosk that contains touch screen panel 92. Such touch screen panel 92 and/or beverage ordering system 90 may be any conventional ordering system as known to one of ordinary skill in the art without departing from the spirit and scope of the present invention.

Robotic beverage server 10 may be programmed to perform a variety of tasks and in a variety of orders. For example, the consumer would swipe a prepaid card into a card reader attached to beverage ordering system 90. The consumer would then order the particular beverage of their choice via pressing the particular beverage icons on touch screen panel 92 (e.g., a whisky and soda). Controller 30 (and/or the computer) receives the drink order and signals robot 20 to begin preparing the ordered beverage. Controller 30 (and/or the computer) will calculate the charge for the beverage(s) and display it on either touch screen 92 or display panel 80 for the consumer to review.

In one embodiment, touch screen 92 will have an accept icon for the consumer to accept the charge(s) for the ordered beverage(s). Robot 20 moves to pick (grab and hold) a beverage container 140 with gripper 28 of one of its arms 26. Robot 20 moves and places beverage container 140 under ice dispenser 60, which dispenses ice into container 140. Once the appropriate amount of ice is dispensed, robot 20 moves to pick an appropriate liquor bottle 120 from active row 122 with gripper 28 of a second arm 26. The robot moves a beverage bottle 140 from a non-dispensing orientation to a dispensing orientation (e.g., tilts the bottle) with its second arm to pour the required amount of liquor from the bottle into the beverage container 140 held within its other arm. In another exemplary embodiment, robot 20 is configured to tilt both the liquor bottle 120 and the beverage container 140 to pour the required amount of liquor from the bottle to the container. In addition, controller 30 may be configured to pour the beverage bottle 120 (e.g., liquor bottle) long enough to pour the required amount of liquor or beverage (e.g., one-ounce shot) from bottle 120 into beverage container 140.

Once the required amount of beverage has been poured from the beverage bottle, robot 20 places bottle 120 back down into its position receptacle 130 along active row 122. After the bottle has been released, robot 20 moves and places beverage container 140 under first beverage dispenser 40 to dispense a second beverage (e.g., a cocktail mixer such as soda, water, fruit juice or drink, etc.). Robot 20 with its second gripper 28 presses a button on panel 42 of first beverage dispenser that corresponds to the second beverage required to prepare the ordered mixed beverage in order to dispense this second beverage into beverage container 140. In another exemplary embodiment, controller 30 may be configured to automatically dispense the appropriate amount of the second beverage (e.g., soda) into the beverage container without requiring robot 20 to manipulate panel 42. Once the appropriate amount of coke is dispensed into the container 140, the second gripper 28 is lifted off the button while the arm holding beverage container 140 may simultaneously moves away from first beverage dispenser 40.

Controller 30 (and/or the computer) may be configured to cause gripper 28 holding beverage container 140 to slightly toggle back and forth to mix the prepared mixture of first and second beverages (e.g., whiskey and soda) before it places the prepared beverage into the chamber (either 115 or 116) of inner cylinder 114 that is sitting in loading position (A). Once container 140 is placed in the chamber and gripper 28 and arm 26 have moved out of the chamber, beverage delivery device 110 rotates 180 degrees to place the chamber containing the prepared beverage in serving position (B), i.e., aligned with serving window 102. At which point, robotic beverage server 10 may alert the consumer via a visual, sound, or any other indicator that the beverage is prepared and ready and thus consumer may open access opening device 90. In another exemplary embodiment, controller 30 may be configured to automatically open and close the window.

In still another exemplary embodiment, framework 70, countertop 74, and barrier 100 are shaped substantially in a circle, wherein robot 20 may be configured to rotate on its base to reach the different components and items to server a beverage. In yet still another exemplary embodiment, framework 70, countertop 74, and barrier 100 comprise a linear layout. In such a layout, robot 20 may be configured to travel along a linear track to access the various components and items along countertop 74 to server a beverage. In addition, it is understood that in any of the various embodiments of the robotic beverage server 10, the beverage supply, container supply, ice dispenser, and deliver device may be configured to increase the serving time (i.e., the time required from the order to consumer pick up—preparation time).

The robotic beverage server of the present invention may also include a wireless receiver/transceiver (not shown) that is in communication with a wireless handheld device (not shown). Alternatively, the robotic beverage server may have a docking station that a handheld device may connect to, placing the handheld device in communication with the robotic beverage server. The waiters/waitresses when taking the consumer's order may enter the order into the handheld device, and then may wirelessly transmit or dock the handheld device to communicate the order to the robotic beverage server. The robotic beverage server may begin preparing the ordered beverages without having to wait for the waiter/waitress to travel back to the robotic beverage server. Thus, this system may reduce the time a consumer has to wait for their drinks. In many cases, by the time the waiter/waitress arrives at the robotic beverage server station, the ordered drinks have already been prepared and are waiting for the waiter pick up.

Although particular embodiments have been described and shown above, it is understood that the robotic beverage server and its components could be positioned in a variety of other designs without departing from the scope of the present invention. Having described the invention in detail and by reference to preferred embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed:

1. A robotic beverage server, comprising a robot, a beverage supply disposed near said robot, a computer connected to said robot, and a beverage ordering system connected to said computer, wherein said computer is configured to permit the entry of available beverages stocked in said beverage supply and operable to determine the variety of beverages and mixtures of beverages that will be available for serving based upon said beverages stocked in said beverage supply.

2. The robotic beverage server according to claim 1, wherein said computer is configured to display said available beverages or mixtures of beverages on said beverage ordering system.

3. The robotic beverage server according to claim 1, wherein said computer is configured to selectively operate said robot to cooperate with said beverage supply to serve a beverage or mixture of beverages from said beverage supply.

4. The robotic beverage server according to claim 1, wherein said computer is operable to collect and store the number of beverages or mixtures of beverages served.

5. The robotic beverage server according to claim 1, wherein said computer is operable to determine inventory available and inventory used based upon the number of beverages or mixtures of beverages dispensed.

6. The robotic beverage server according to claim 1, wherein said computer is operable to collect and store sales and revenue data for beverages or mixtures of beverages dispensed.

7. The robotic beverage server according to claim 1, wherein said computer is configured to be in communication with a network to aggregate all inventory, accounting, sales, and revenue data for one or more robotic beverage servers.

8. The robotic beverage server according to claim 1, wherein said beverage ordering system is configured to permit an user to order a beverage or mixture of beverages.

9. The robotic beverage server according to claim 1, wherein said beverage ordering system is configured to permit an user to accept a corresponding charge for a beverage or mixture of beverages ordered by the user.

10. The robotic beverage server according to claim 9, wherein said beverage ordering system is configured to accept a magnetic strip card to charge an account of the user for the ordered beverage or mixture of beverages.

11. The robotic beverage server, comprising:
a robot;
a framework at least partially encompassing said robot;
a beverage supply disposed within said framework;
a barrier disposed above said framework such that said barrier at least partially encompasses said robot, said barrier including an opening therein;
a controller configured such that said robot cooperates with said beverage supply to serve a beverage or mixture of beverages from said beverage supply to an user through said opening;
wherein said framework and barrier are configured to prevent an user from gaining access to said robot.

12. The robotic beverage server according to claim 11, further comprising a beverage delivery device disposed at said opening of said barrier and configured such that when said robot places a beverage container thereon, said beverage delivery device moves the container to said opening and permits an user access to only the beverage container behind said barrier.

13. The robotic beverage server according to claim 12, wherein said beverage delivery device comprises an outer cylindrical housing disposed within said barrier at said opening and an inner cylinder rotatable within said outer cylindrical housing between a first position and a second position.

14. The robotic beverage server according to claim 11, wherein said opening of said barrier includes an access opening device movably connected to said barrier, and wherein said controller is configured to prevent said access opening device from moving to an open position if said robot or beverage delivery device is moving.

15. The robotic beverage server according to claim 14, further comprising a first sensor in communication with said controller and configured to detect whether said access opening device is in an open or closed position.

16. The robotic beverage server according to claim 11, wherein said controller is configured to prevent said beverage delivery device from moving if said access opening device is in an open position.

17. The robotic beverage server according to claim 12, further comprising:
first and second sensors configured to sense the presence of a beverage container and in communication with said controller, wherein said controller is configured to move said beverage delivery dispenser if said first sensor detects a beverage container but said second sensor does not detect a beverage container or if said second sensor detects a beverage container and said first sensor does not detect a beverage container.

18. The robotic beverage server, comprising:
a robot;
a framework at least partially encompassing said robot;
a beverage supply disposed within said framework;
a beverage container supply disposed within said framework;
a barrier disposed along said framework such that said barrier at least partially encompasses said robot, said barrier including an opening therein;
a beverage delivery device disposed at said opening of said barrier and configured such that when said robot places a beverage container thereon, said beverage delivery device moves the container to said opening and permits a customer access to only the beverage container behind said barrier;
a controller configured to cause said robot to pick a beverage container from said beverage container supply and to cooperate with said beverage supply to server a beverage or mixture of beverages from said beverage supply.

19. The robotic beverage server according to claim 18, wherein said barrier is connected to said framework such that said barrier is positioned above said framework.

20. The robotic beverage server according to claim 18, wherein said framework comprises a countertop and cabinets.
